(19) United States
(12) Patent Application Publication
(10) Pub. No.: US 2004/0259630 A1
(43) Pub. Date: Dec. 23, 2004

(54) Method and apparatus for the rewarding of the interest of a user in an activity

(76) Inventors: Marcel Huard, St-Romuald (CA); Real Berube, St-Jean-Chrysostome (CA); Martin Benoit Gagnon, Charlesbourg (CA)

Correspondence Address: OGILVY RENAULT, 1981 MCGILL COLLEGE AVENUE, SUITE 1600, MONTREAL, QC, H3A2Y3, CA

(21) Appl. No.: 10/462,766

(22) Filed: Jun. 17, 2003

(51) Int. Cl. A63F 13/00

(52) U.S. Cl. 463/25

(57) ABSTRACT

A method and system for rewarding a user's interest in an activity is provided. It comprises identifying a location for the user; determining a period of time during which the user is to maintain interest in the activity; monitoring an interest of the user in the activity for the period of time, at the location; deciding if a prize should be awarded to the user if the user has maintained an interest for the period of time, at the location; and choosing and awarding the prize to the user if the decision is positive; whereby the user can be rewarded for having maintain his interest in the activity.

### FIELD OF THE INVENTION

The invention relates to a method and system for controlling and managing the awarding of prizes. More specifically, it relates to awarding benefits to users who are located within a predetermined environment for a predetermined period of time.

### BACKGROUND OF THE INVENTION

In advertising, maintaining the interest of the public is of extreme importance. The target audience of an advertisement must stay interested in the ad for a period of time long enough to recognize the brands and the products and remember the message of the campaign.

A challenge for the advertisers on the Internet is that the users will simply close the pop-up windows that feature ads or will ignore them while continuing to browse.

Similarly, in casinos, the interest of the player has to be maintained to ensure revenues for the casino house. Typically, auxiliary games are offered to the players in addition to the underlying principal casino game. The auxiliary games offer additional opportunities to win and have very simple rules to avoid disturbing or slowing the principal casino game. The auxiliary game is an incentive for the player to continue to play in the principal casino game. The auxiliary bets required to participate in the auxiliary game are an additional source of profit for the casino house. The auxiliary games, however, do not entice a player to stay at a particular table for a specific length of time since the auxiliary game is usually reset when the principal game ends.

Therefore, there is a need to maintain the interest of users or player in a plurality of activities for a certain length of time.

### SUMMARY OF THE INVENTION

Accordingly, an object of the present invention is to give a player a chance to obtain a prize if he has maintained his interest in an activity, from a specific location, for a period of time.

According to one broad aspect of the present invention, there is provided a system for rewarding a user's interest in an activity, comprising: a locator for identifying a location for the user; a timer for determining a period of time during which the user is to maintain interest in the activity; an activity monitor, communicating with the locator and the timer, for monitoring an interest of the user in the activity for the period of time, at the location; a selector for deciding if a prize should be awarded to the user if the activity monitor indicates that the user has maintained an interest for the period of time, at the location; and a prize distributor for choosing and awarding the prize to the user if the decision is positive; whereby the user can be rewarded for having maintain his interest in the activity.

According to another broad aspect of the present invention, there is provided a method for rewarding a user's interest in an activity, comprising: identifying a location for the user; determining a period of time during which the user is to maintain interest in the activity; monitoring an interest of the user in the activity for the period of time, at the location; deciding if a prize should be awarded to the user if the user has maintained an interest for the period of time, at the location; and choosing and awarding the prize to the user if the decision is positive; whereby the user can be rewarded for having maintain his interest in the activity.

### BRIEF DESCRIPTION OF THE DRAWINGS

These and other features, aspects and advantages of the present invention will become better understood with regard to the following description and accompanying drawings wherein:

FIG. 1 is an illustration of the physical environment of one embodiment of the invention, in a casino setting;

FIG. 2 is an illustration of the physical environment of a second embodiment of the invention, in a retail store setting;

FIG. 3 is an illustration of the physical environment of a third embodiment of the invention, in a remote location setting;

FIG. 4 is a block diagram of the main components of a preferred embodiment of the invention; and

FIG. 5 is a flow chart of the main components of a preferred embodiment of the invention.

### DETAILED DESCRIPTION OF THE PREFERRED EMBODIMENT

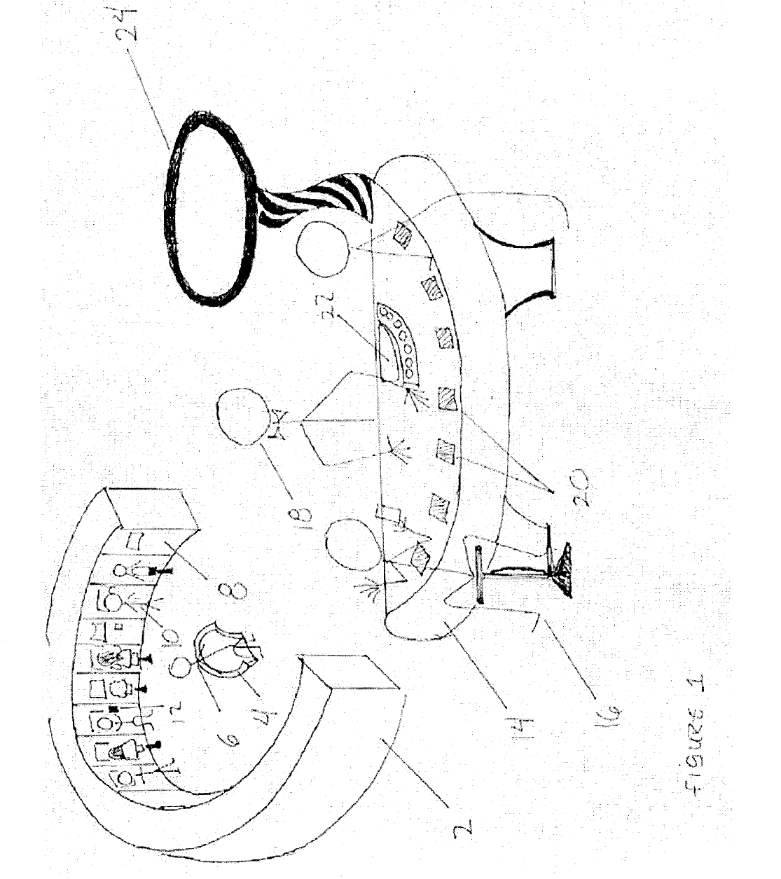

In FIG. 1, the physical environment of one embodiment of the invention, in a casino setting is shown. Players 16 are seated at a casino table 14. A dealer 18 is assigned to that table. The dealer has a control console 22 and each player position at the table bears a locator 20. A display 24 is provided.

Other players 10 are located in the slot machines area 2, where individual slot machines 8 are located. A casino employee 6 is located in a control booth 4.

A system for rewarding a user's interest in an activity is provided and comprises a locator 20, 22, 4 for identifying a location for the user. In this embodiment, the location of the player is determined by at least one of three preferred ways: the player can identify his own location using the locator 20, the dealer can enter a location code in the control console 22 or the casino employee 6 can enter a location code in the control booth 4. Individual locators (not shown) could also be provided on each slot machine 8. Casino employees or players could also carry portable locators (such as handheld devices, identification cards, etc.) which, if wireless, could send a location signal to a positioning receiver, or could be used to enter location information directly in a location apparatus provided on the table, the slot machine, etc. The casino employee could be responsible for a section of the casino and could enter the location information about the players in a handheld device. A keypad could also be provided at a player position to let the player enter personal information directly.

The locators can be of any type, they can be a sensor on a chair assigned to a player position at a table or a slot machine and emitting a signal having an identification code for the location that the activity monitor can receive, a keypad requiring a personal identification number to be entered regularly by the player, a bet detector detecting the presence of a bet and therefore of a user at the position, an entry by the dealer in his console that a player has taken up a position at the table, an entry by the casino employee that a player has taken up a position at a slot machine, etc. When a console is provided to the dealer 22, or to an employee 6, a keypad can be provided to enter information concerning the time of arrival of the player, his location, his activity and his time of departure from the position. Other means of identifying players can be used such as face recognition systems, iris mapping systems, fingerprinting, etc.

A timer is provided for determining a period of time during which the user is to maintain interest in the activity. In this embodiment, the activity can be playing a principal or auxiliary casino table game, watching players play a casino table game from a nearby or remote location, playing at a slot machine, playing bingo or keno, etc. The timer can be preset to a specific duration of time or can randomly decide of a period of time during which the monitoring of the interest of the players will occur. The length of time can depend on the type of activity of the user. For example, a player playing at a $100 minimum bet table may only need to maintain interest in the activity for one minute to participate while a player at a $0.25 slot machine may need to maintain interest in the activity for ten minutes. Users watching other players may need to maintain interest for one full hour. The length of time can also vary depending on the time of day, for example, a happy hour period from 5:00 PM to 7:00 PM may require an interest period of only five minutes while a period of time of fifteen minutes is required during the rest of the day. To prevent a synchronization of the players on the timer in cases where the length of time is predetermined to be Z minutes, an average of Z minutes could be attained over a plurality of monitoring periods.

An activity monitor, communicating with the locator and the timer, is provided for monitoring an interest of the user in the activity for the period of time, at the location. The activity monitor receives an indication of the period of time from the timer and receives a signal from the locator that a player is located at a particular location, such as a player position at a casino table. During the period of time, the monitor verifies if the same player is located at the location and maintain his interests in the activity. If the required activity is betting in a casino table game, the monitor receives an indication from the locators and/or from the dealer/employee console as to whether the player is continuously betting or if he has stopped. Depending on the conditions chosen for the monitoring, a player who stops betting in the casino table game but remains at his original location may be eligible to the reward or his participation may be rejected.

If at least one user has maintained an interest for the period of time, at his own location, a selector decides if a prize should be awarded to the user. Preferably, only one player is chosen by the selector for each period of time of monitoring. This person is called a “Lucky Player”. However, in other embodiments, a plurality of players can be chosen to be rewarded. When a plurality of players are chosen, they can be selected because they all belong to the same table, for example. In the case where all players at a particular casino table would be eligible to be rewarded, the selector could decide to choose all of them. The random selection can be carried out by a casino employee or by an electronic, software or electromechanical apparatus. Preferably, each time a player is eligible for the random selection, he earns at least one free credit to participate in a future monitoring session.

Different criteria can affect the selection of a player as a Lucky Player. For example, the player's profile, accumulated credits, time spent carrying out the activity, amount bet, type of activity, the minimal bet for the game, the drop amount (amount of cash exchanged for casino credits at once), etc. For example, a player who bet $40 in a two-minute period would have more chances of being chosen as the Lucky Player than a player who bet $20 in the same two-minute period.

If a prize is to be awarded, a prize distributor chooses the prize and awards the prize to the user. The prize can be chosen depending on the activity for which interest was maintained or depending on the length of time for which the interest was maintained. Similarly, the prize can depend on the time of day or the profile of the user, if available. A jackpot can be accumulated and awarded after a number x of players have been monitored or after an amount y has been accumulated in the jackpot, or in any other way. The prize can be randomly chosen from a prize list. If a player is repeatedly eligible for the reward, a bigger may be awarded to him if and when he is chosen by the selector.

The selection of a Lucky Player can have different aspects. For example, each position in the casino can have a position number, a table number and aisle letter. A match between at least one of these aspects and an eligible player position gives that lucky player a prize. For example, a player is playing is aisle B of the casino at table 3, position 2. His identification code is therefore B32. If the selector selects B45, namely, in aisle B, the table number 4 and the position 5, the player has a match for the aisle, he can therefore be awarded a small prize. If the match is the table number and the player position, the prizes can be bigger. If a player matches two or three of these aspects, the prizes are even higher.

The prize is then awarded to the player. If it is a credit amount, the prize can simply be credited to the player's electronic bank. If it is a large amount, an object or a service, such as a trip, the player can be called to attend a special ceremony.

The prize awarded can be a number of Lucky Player points that can then be exchanged for a gift or a dollar amount.

Many casino tables, slot machines areas and casinos can be networked and the monitoring can be centralized. Then, in addition to obtaining a location of a player within a casino, a casino location is also obtained to uniquely identify the player. The casino location information can include a street, a town, a state, a country, a continent, etc.

When the player is chosen to be rewarded, a message can be displayed on a display near his table and/or on all displays for positions being monitored by this system. Preferably, the message is accompanied by sound and visual effects, especially near the location of the chosen player. When many positions are participating in this reward system, excitement can be built by giving very general information on the player chosen and continuing with more precise information until the player is identified. For example, the city where the casino is located, the name of the casino, the floor on which the player is, the aisle in which the player is, the table at which the player is seated and finally, the position at the table.

The system can further include a participation acceptor for recording a participation of the user in the monitoring. Indeed, a player may wish to be excluded from the monitoring and a switch can be provided to let the player express his desire to participate or not in the monitoring.

In some embodiments, the participation in the monitoring and potential rewarding may require payment of a fee. The participation acceptor then comprises a credit acceptor for receiving an amount of credits required to participate in the monitoring. The credit acceptor can be an electronic bank.

The player is therefore confined to a specific game location—at a game table, at a gaming machine or at another casino position such as at a bar, at a bingo or a keno playing position, etc—for a period of time determined between the participation and the winning of the prize. This method and system allow to present offers in/or targeted activities and personalized activities to a player occupying a precise position carrying out a precise activity and, consequently, to establish positive reinforcement associations for the player to the physical location and the activity carried out by the player. This method and system is completely independent of the principal game being played and can be played with any principal game—at a gaming table or at a gaming machine or at another game location. Moreover, everybody playing at a game table and/or at a gaming machine can participate in this game and thereby accumulate bigger jackpots that can be awarded more frequently to players.

The player believes that he has control over which position he is playing at and therefore has control over the outcome of the game, thereby making him more eager to participate in this form of auxiliary game. Because the players cannot leave their specific position in the casino, the casino is insured of increased revenues because the player will play until the prize is awarded to make sure that he does not lose his potential prize.

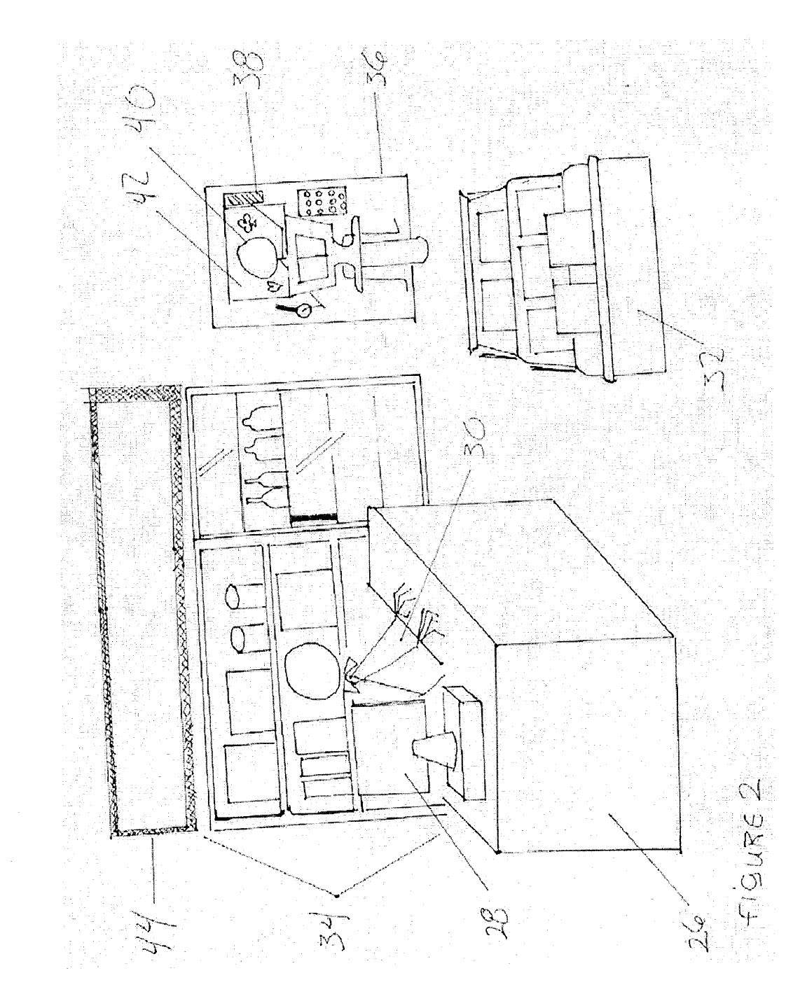

FIG. 2 shows the physical environment of a second embodiment of the invention, in a retail store setting. The retail store has a counter 26 with a transaction system 28 which is controlled by a store employee 30. Magazine shelves 32 and storage for retail store products 34 are shown. A gaming apparatus 36 is located in a corner of the store. A locator 38 is provided which detects the presence of a person in front of the machine. A player 40, potentially also a customer of the retail store is seated in front of the machine. A display 42 for the game played by the player is provided on the machine. A further store display 44 is provided in the store.

The system works as in the first embodiment of FIG. 1 although only one player is located in this particular store. The device can be a standalone device and the timer can be set to reward a player who remains playing for an extended period of time or can be networked with other stores, a nearby casino or casino network and therefore be included in a bigger pool of players. The display can be used to publicize to the customers of the store that the player at the machine was just chosen as a lucky player.

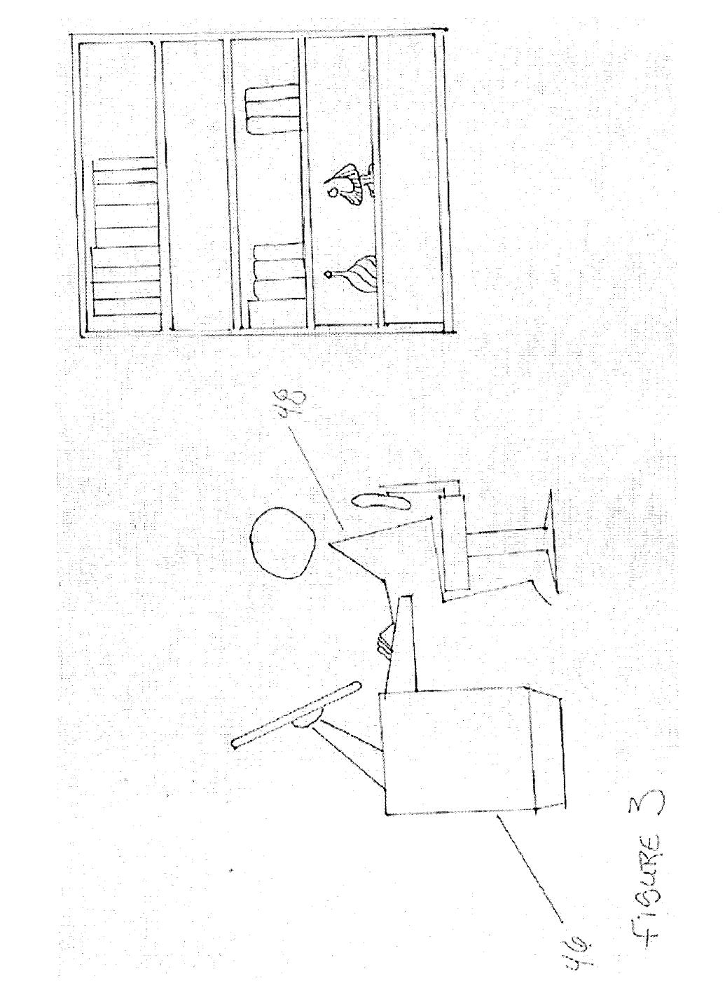

The physical environment of a third embodiment is shown in FIG. 3. The user 48 is connected to the Internet using a computer 46. The user can be at home or in other public or private locations such as libraries, hotels, bars, cafes, restaurants, etc.

The activity being monitored can be the connection to a predetermined website on the Internet. This website can be a gaming website or any other website. The activity can be a simple browsing of a page or the participation in an online game.

The locator identifies a location for the computer currently used by the user to maintain interest in the activity. The locator can, for example, ensure that the user is accessing the website from a state where such a system is permitted. An identification of the computer used is obtained to monitor the location of the player during the length of time. There are a variety of ways to uniquely authenticate a specific computer. Solutions can include physical identification hardware or software that looks at the hardware on a computer. The geographic location can be obtained from the Internet Service Provider or from an internet connected GPS device.

The Player would log in, enter his password and give a unique identification for his access computer to render his access computer an authorized station for the participation in the monitoring. Therefore, this monitoring requires that the participant begins to play and claims his prizes from the same computer. Preferably, the unique identification for the computer would act as the monitoring ticket number or participation token.

The player is required to stay logged on during the waiting period between the participation in the monitoring and the awarding of the prize. During that time, he can either play another game, do nothing, receive personalized advertisement on his screen from the monitoring website, etc.

Again, the monitoring of the user can be networked with a plurality of other players.

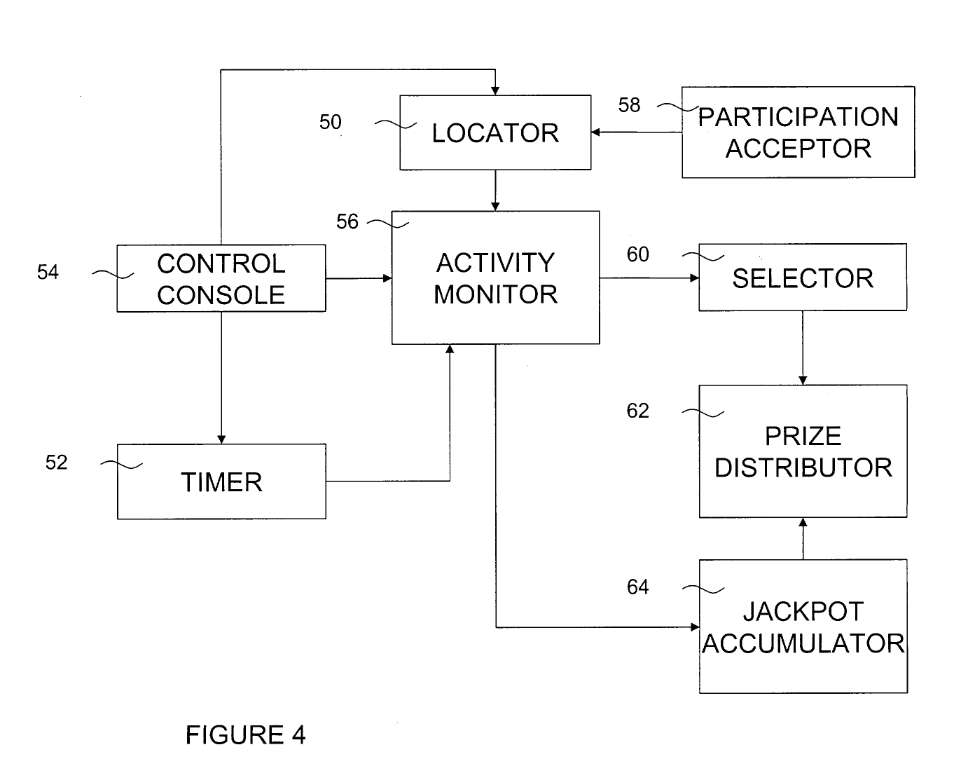

FIG. 4 is a block diagram of the main components of the preferred embodiment of the present invention. A locator 50 provides a location for a player to an activity monitor 56. A control console 54 for a dealer, an employee or the player can also provide information about the player to the locator 50 and/or the activity monitor 56. A participation acceptor 58 can be used to accept a participation by the user. A timer 52 can also receive the information about the player from the control console 54. The timer 52 then provides a period of time to the activity monitor for which the interest of the player will be monitored.

A selector 60 receives an indication from the activity monitor 56 that a player is eligible to win by having maintained his interest in the activity from the same location for the determined period of time. A prize distributor 62 is used to determine the prize and a jackpot accumulator 64 can be used to accumulate a jackpot and award it.

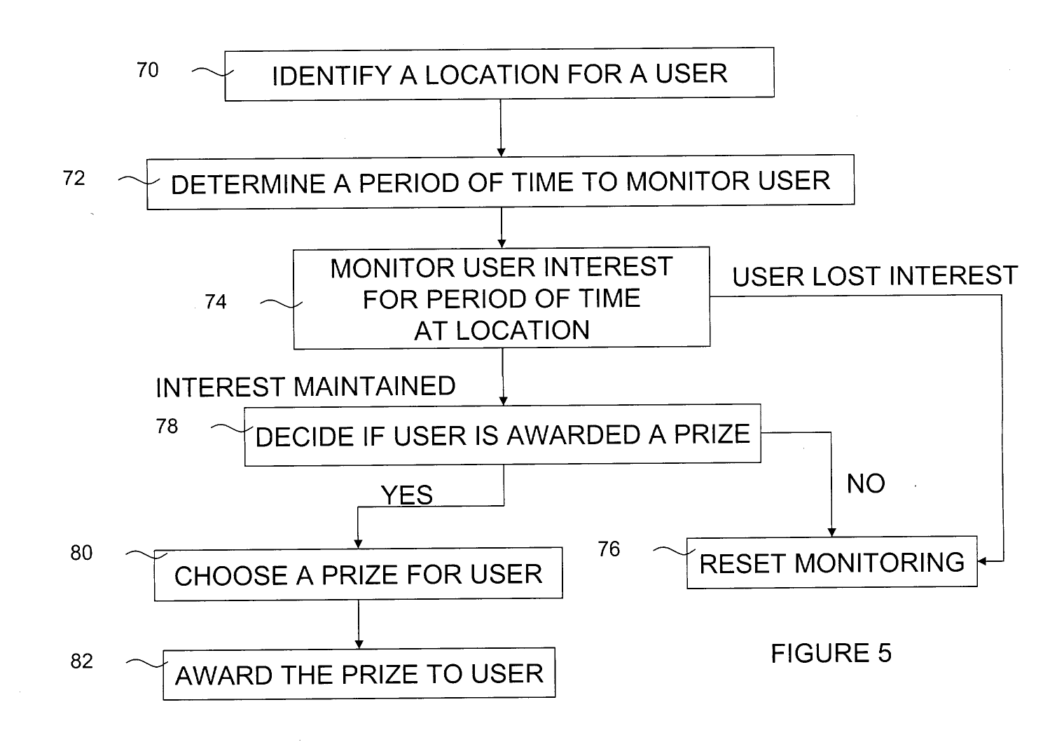

FIG. 5 is a flow chart of the main steps of the preferred embodiment. A location of a user is identified 70. A period of time to monitor the user is determined 72. The user interest is monitored for the period of time at the location 74. If the user lost interest, the monitoring is reset 76. If the interest was maintained, a decision is made at to whether a prize should be awarded to the player 78. If a prize should be awarded, a prize is chosen 80 and awarded 82. If a prize is not awarded, the monitoring is reset 76.

In addition to the monitoring of the interest of the player, a tracking system could be used to establish a player profile and to target publicity for the player. Also, the tracking system could be used to transfer points or credits obtained by the player during the monitoring to other locations where they could be used to participate in the monitoring. For example, an electromagnetic card could be provided to each player and could be used to identify the player at each location and to store reward information.

This card would allow other prize choices. For example, a player could accumulate Lucky Player points, each time he is selected until a number Z of points is attained which would allow him to obtain a bigger prize.

Additionally, all players selected as Lucky Players can be automatically or manually entered in a periodic grand prize draw

A dealer dealing at the time of the selection of a Lucky Player could be awarded a percentage of the prize or a bonus.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium or an electrical or electro-magnetical signal.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

What is claimed is:

1. A system for rewarding a user's interest in an activity, comprising:
a locator for identifying a location for said user;
a timer for determining a period of time during which said user is to maintain interest in said activity;
an activity monitor, communicating with said locator and said timer, for monitoring an interest of said user in said activity for said period of time, at said location;
a selector for deciding if a prize should be awarded to said user if said activity monitor indicates that said user has maintained an interest for said period of time, at said location; and
a prize distributor for choosing and awarding said prize to said user if said decision is positive;
whereby said user can be rewarded for having maintain his interest in said activity.

2. A system as claimed in claim 1, wherein said user is a player of a game.

3. A system as claimed in claim 2, wherein said activity is playing in a principal casino table game.

4. A system as claimed in claim 3, wherein said location is a seat at a casino table of a casino wherein said principal casino table game is played.

5. A system as claimed in claim 1, wherein said period of time is ten minutes.

6. A system as claimed in claim 1, further comprising a control console to provide information concerning said user to at least one of said locator, said timer and said activity monitor.

7. A system as claimed in claim 1, wherein said locator is a sensor detecting a presence of said user at said location and emitting a signal having an identification code for said location and wherein said activity monitor receives said signal.

8. A system as claimed in claim 1, wherein said timer comprises a generator for randomly generating a period of time for said monitoring.

9. A system as claimed in claim 6, wherein said console comprises a keypad for letting an administrator enter a code to provide said information.

10. A system as claimed in claim 2, wherein said activity monitor comprises a bet sensor for sensing if said user has placed a bet on said game.

11. A system as claimed in claim 1, wherein said prize distributor comprises a prize list from which a prize is chosen and awarded to said user.

12. A system as claimed in claim 11, wherein said prize distributor uses an indication of said period of time to choose said prize.

13. A system as claimed in claim 1, wherein said prize distributor comprises an electronic bank, wherein said prize is a credit amount and wherein said electronic bank is credited by said credit amount if said prize is awarded.

14. A system as claimed in claim 1, further comprising a jackpot accumulator for accumulating a jackpot amount available to be chosen as a prize by said prize distributor.

15. A system as claimed in claim 1, further comprising a participation acceptor for recording a participation of said user in said monitoring.

16. A system as claimed in claim 15, wherein said participation acceptor comprises a credit acceptor for receiving an amount of credits required to participate in said monitoring.

17. A system as claimed in claim 16, wherein said credit acceptor is an electronic bank.

18. A system as claimed in claim 1, further comprising a plurality of said locators, for identifying a location of each of at least one of a plurality of said users.

19. A system as claimed in claim 18, wherein said selector selects only one of said plurality of said users who has maintained an interest for said period of time, at each of said locations.

20. A system as claimed in claim 1, wherein said timer determines said period of time using a type of said activity.

21. A system as claimed in claim 1, wherein said user is connected to a network using a terminal.

22. A system as claimed in claim 21, wherein said network is Internet and wherein said terminal is a computer.

23. A system as claimed in claim 21, wherein said locator identifies a location for said terminal currently used by said user to maintain interest in said activity.

24. A system as claimed in claim 22, wherein said activity is being connected to a predetermined website on the Internet.

25. A system as claimed in claim 21, wherein said activity is participating in a game.

26. A system as claimed in claim 1, wherein said activity monitor comprises a participation checker for checking if said user participated in said activity throughout said period of time.

27. A system as claimed in claim 1, wherein said selector is a random selector.

28. A system as claimed in claim 1, wherein said prize is at least one of a number of credits, a prize, a dollar amount and a number of points.

29. A system as claimed in claim 1, further comprising a profile builder for tracking a profile for said user, said profile having at least one of a duration of said interest, a type of said activity and a record of prizes won by said user.

30. A system as claimed in claim 1, further comprising a display for displaying information concerning at least one of said user, said location, said period of time and said prize.

31. A method for rewarding a user's interest in an activity, comprising:
identifying a location for said user;
determining a period of time during which said user is to maintain interest in said activity;
monitoring an interest of said user in said activity for said period of time, at said location;
deciding if a prize should be awarded to said user if said user has maintained an interest for said period of time, at said location; and
choosing and awarding said prize to said user if said decision is positive;
whereby said user can be rewarded for having maintain his interest in said activity.

32. A method as claimed in claim 31, wherein said user is a player of a game.

33. A method as claimed in claim 32, wherein said activity is playing in a principal casino table game.

34. A method as claimed in claim 33, wherein said location is a seat at a casino table of a casino wherein said principal casino table game is played.

35. A method as claimed in claim 31, wherein said period of time is ten minutes.

36. A method as claimed in claim 31, further comprising providing information concerning said user for at least one of said identifying, determining and monitoring.

37. A method as claimed in claim 31, wherein said identifying comprises detecting a presence of said user at said location and emitting a signal having an identification code for said location and wherein said monitoring comprises receiving said signal.

38. A method as claimed in claim 31, wherein said determining comprises randomly generating a period of time for said monitoring.

39. A method as claimed in claim 32, wherein said monitoring comprises sensing if said user has placed a bet on said game.

40. A method as claimed in claim 31, wherein said choosing comprises choosing from a prize list.

41. A method as claimed in claim 40, wherein said choosing uses an indication of said period of time.

42. A method as claimed in claim 31, further comprising accumulating a jackpot amount available to be chosen as a prize.

43. A method as claimed in claim 31, further comprising recording a participation of said user in said monitoring.

44. A method as claimed in claim 31, further comprising identifying a location of each of at least one of a plurality of said users.

45. A method as claimed in claim 44, wherein said deciding selects only one of said plurality of said users who has maintained an interest for said period of time, at each of said locations.

46. A method as claimed in claim 31, wherein said determining uses a type of said activity.

47. A method as claimed in claim 31, wherein said user is connected to a network using a terminal.

48. A method as claimed in claim 47, wherein said network is Internet and wherein said terminal is a computer.

49. A method as claimed in claim 47, wherein said identifying comprises identifying a location for said terminal currently used by said user to maintain interest in said activity.

50. A method as claimed in claim 48, wherein said activity is being connected to a predetermined website on the Internet.

51. A method as claimed in claim 47, wherein said activity is participating in a game.

52. A method as claimed in claim 31, wherein said monitoring comprises checking if said user participated in said activity throughout said period of time.

53. A method as claimed in claim 31, wherein said deciding is a random decision.

54. A method as claimed in claim 31, wherein said prize is at least one of a number of credits, a prize, a dollar amount and a number of points.

55. A method as claimed in claim 31, further comprising tracking a profile for said user, said profile having at least one of a duration of said interest, a type of said activity and a record of prizes won by said user.

56. A method as claimed in claim 31, further comprising displaying information concerning at least one of said user, said location, said period of time and said prize.
